(19) United States
(12) Patent Application Publication
(10) Pub. No.: US 2026/0098116 A1
(43) Pub. Date: Apr. 9, 2026

(54) OPTICAL ELEMENT, RESIN COMPOSITION, OPTICAL INSTRUMENT AND IMAGING APPARATUS

(71) Applicant: CANON KABUSHIKI KAISHA, Tokyo (JP)

(72) Inventor: HIDEO UKUDA, Kanagawa (JP)

(21) Appl. No.: 19/349,675

(22) Filed: Oct. 3, 2025

(30) Foreign Application Priority Data
Oct. 9, 2024 (JP) 2024-177199

(51) Int. Cl. C08F 222/10; G02B 1/04

(52) U.S. Cl. CPC C08F 222/1063; G02B 1/041; C08F 2800/20

(57) ABSTRACT

An optical element including, on a transparent substrate, a cured product obtained by polymerizing and curing a resin composition. The resin composition contains a polyfunctional urethane-modified (meth)acrylate compound, a bifunctional (meth)acrylate compound having a bisphenol skeleton, and a polymer obtained by polymerizing a polymerizable compound (monomer) having any of a tricyclodecane skeleton, an isobornyl skeleton, a dicyclopentenyl skeleton, and an adamantane skeleton. A replica element is provided that has a low water absorption expansion coefficient, a high refractive index, and excellent durability.

### BACKGROUND

### Field of the Technology

The present disclosure relates to an optical element, a resin composition used for manufacturing the optical element, and an optical instrument and an imaging apparatus using the optical element.

### Description of the Related Art

As one type of optical element, a lens is known in which a cured product of a resin composition is provided on a transparent substrate such as glass. Such a lens is manufactured by using a molding die, filling a resin composition between the substrate and the molding die, polymerizing or copolymerizing the resin composition, and forming a cured product of a desired shape on the substrate surface. A lens manufactured by such a manufacturing method is called a replica element. Since a replica element can easily form a desired surface shape, it is effective for use as an aspherical lens or a Fresnel lens. An aspherical lens is a general term for a lens in which the curvature changes continuously from the center of the lens to the periphery. Japanese Patent Laid-Open No. H06-298886 and U.S. Pat. No. 7,070,862 disclose resin compositions that can be used for replica elements.

However, since the cured product of the resin composition disclosed in Japanese Patent Laid-Open No. H06-298886 has a high water absorption expansion coefficient, its optical performance is prone to change in, for example, a high-humidity environment. On the other hand, the cured product of the resin composition disclosed in U.S. Pat. No. 7,070,862 has a higher refractive index compared to the one described in Japanese Patent Laid-Open No. H06-298886, providing the advantage that the resin thickness can be kept low even if the aspherical effect is increased. The water absorption expansion coefficient is also lower than that of the one described in Japanese Patent Laid-Open No. H06-298886, but when the aspherical effect is increased, the film thickness becomes large, making the water absorption characteristics insufficient. It is also considered that the environmental durability is not sufficient.

### SUMMARY

The present disclosure provides a replica element that has a low water absorption expansion coefficient, a high refractive index, and excellent durability.

A first aspect of the present disclosure is a resin composition comprising at least the following components (A) to (C).
(A) A polyfunctional urethane-modified (meth)acrylate compound
(B) A bifunctional (meth)acrylate compound having a bisphenol skeleton represented by the following general formula (1)
(C) A polymer represented by the following general formula (6) having at least one alicyclic skeleton represented by the following structural formulae (2) to (4) and general formula (5)

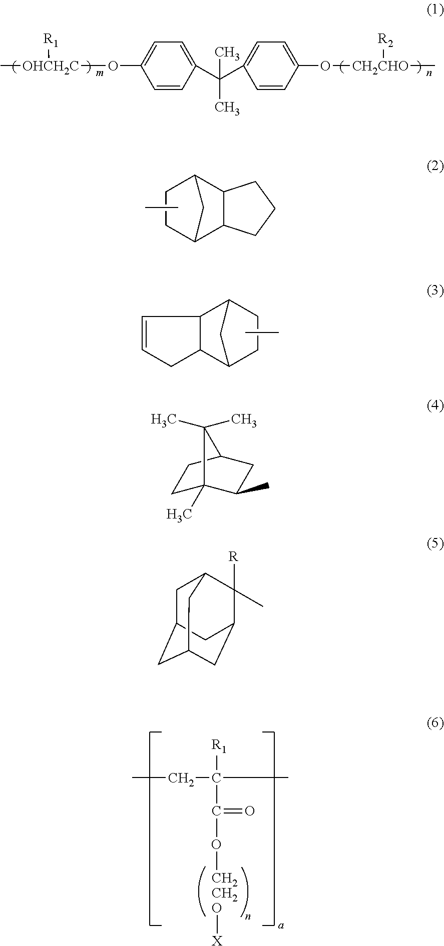

In the above general formula (1), R₁ and R₂ each independently represent a hydrogen atom or a methyl group, and m and n represent numerical values.

In the above general formula (5), R is a hydrogen atom, an alkyl group, or a substituted or unsubstituted alkylene group.

In the above general formula (6), R₁ represents a hydrogen atom or a methyl group, n is 0 or 1, a represents a numerical value, and X represents an alicyclic skeleton represented by any of the above structural formulae (2) to (4) and general formula (5).

A second aspect of the present disclosure is an optical element including a cured product of the resin composition of the first aspect,
the cured product has a glass transition point of 105° C. or higher and 160° C. or lower, and
the cured product has a refractive index at a d-line of 1.54 or higher.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an embodiment of an optical element according to the present disclosure.

FIG. 2A is a schematic diagram illustrating an embodiment of a method for manufacturing an optical element according to the present disclosure.

FIG. 2B is a schematic diagram illustrating an embodiment of a method for manufacturing an optical element according to the present disclosure.

FIG. 3 is a schematic diagram illustrating an embodiment of an imaging apparatus according to the present disclosure.

FIG. 4 is a schematic diagram illustrating the thickness of a cured product in an optical element of an example of the present disclosure.

### DESCRIPTION OF THE EMBODIMENTS

### [Optical Element]

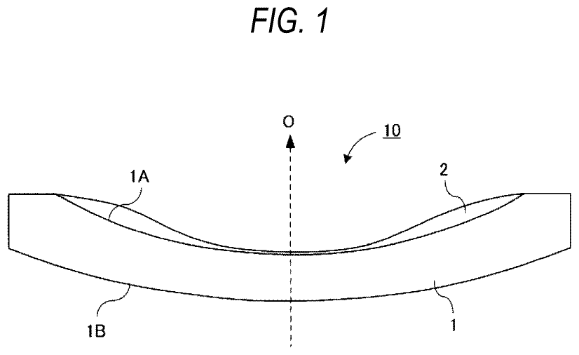

FIG. 1 is a schematic diagram illustrating an optical element according to a first embodiment of the present disclosure, and is a side cross-sectional view of the optical element 10 cut along a plane passing through the element center O of the optical element 10 in the stacking direction. The optical element 10 includes a transparent substrate 1 and a cured product 2. The optical element 10 is a type of optical element called a replica lens, in which a cured product is provided on a transparent substrate.

### (Transparent Substrate)

The transparent substrate 1 has a first surface 1A and a second surface 1B, which are optical surfaces. The first surface 1A of the transparent substrate 1 is one of a light incident surface or a light exit surface, and the second surface 1B of the transparent substrate 1 is the other of the light incident surface or the light exit surface. As the transparent substrate 1, a transparent resin or transparent glass can be used. In this specification, “transparent” indicates that the transmittance of light in a wavelength range of 400 nm or more and 780 nm or less is 10% or more. It is preferable to use glass for the transparent substrate 1, and for example, general optical glass represented by silicate glass, borosilicate glass, or phosphate glass, or quartz glass or glass ceramics can be used. A surface treatment may also be performed with a silane coupling agent or the like. Also, a transparent adhesive or a transparent organic resin layer that serves as a buffer layer may be provided between the transparent substrate 1 and the cured product 2 described later.

In FIG. 1, the first surface 1A has a concave spherical shape, and the second surface 1B has a convex spherical shape, but the shape of the transparent substrate 1 is not particularly limited. The shape of the surface of the transparent substrate 1 that is in contact with the cured product 2 can be selected from a concave spherical surface, a convex spherical surface, an axially symmetric aspherical surface, a flat surface, and the like, according to desired characteristics. The transparent substrate 1 is preferably circular when viewed from above in the plane of the paper of FIG. 1. This is because the accuracy of assembly is improved when the optical element 10 is used as a lens in an optical system described later.

### (Cured Product)

In FIG. 1, the cured product 2 is provided in close contact on the first surface 1A of the transparent substrate 1. However, as described above, a transparent adhesive or a transparent organic resin layer that serves as a buffer layer may be provided between the transparent substrate 1 and the cured product 2. The cured product 2 is a cured product of a resin composition obtained by polymerizing or copolymerizing the resin composition. The resin composition contains at least the following components (A) to (C), and preferably further has component (D) as a polymerization initiator.
(A) A polyfunctional urethane-modified (meth)acrylate compound
(B) A bifunctional (meth)acrylate compound having a bisphenol skeleton represented by the following general formula (1)
(C) A polymer represented by the following general formula (6) having at least one alicyclic skeleton represented by the following structural formulae (2) to (4) and general formula (5)

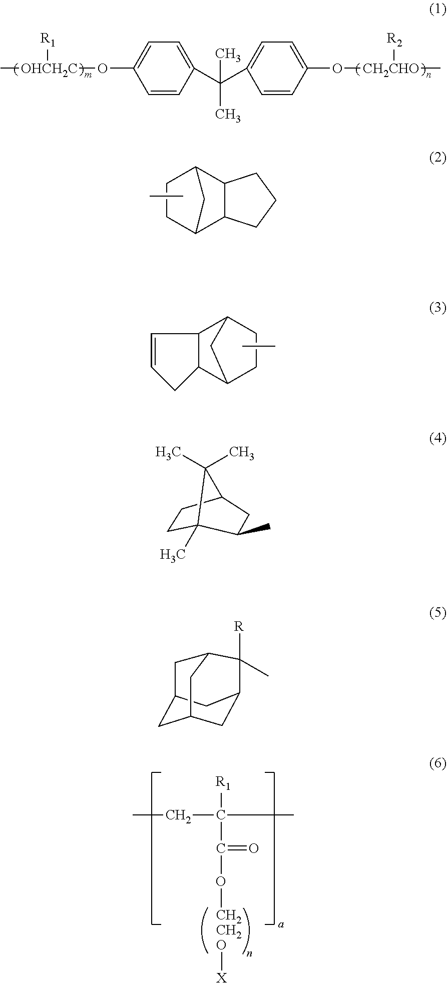

In the above general formula (1), R₁ and R₂ each independently represent a hydrogen atom or a methyl group, and m and n represent numerical values. m+n is preferably 2 or more and 30 or less. In the above general formula (5), R is a hydrogen atom, an alkyl group, or a substituted or unsubstituted alkylene group. In the above general formula (6), R₁ represents a hydrogen atom or a methyl group, n is 0 or 1, a represents a numerical value, and X represents an alicyclic skeleton represented by any of the above structural formulae (2) to (4) and general formula (5). Note that in general formula (6), an initiator is bonded to the left end, and a substituent bonded at the time of polymerization termination is bonded to the right end.

The alicyclic skeleton represented by structural formula (2) is a tricyclodecane skeleton. The alicyclic skeleton represented by structural formula (3) is an isobornyl skeleton. The alicyclic skeleton represented by structural formula (4) is a dicyclopentenyl skeleton. The alicyclic skeleton represented by general formula (5) is an adamantane skeleton. A polymer obtained by polymerizing a polymerizable compound (monomer) having any of a tricyclodecane skeleton, an isobornyl skeleton, a dicyclopentenyl skeleton, and an adamantane skeleton serves the function of lowering the water absorption expansion coefficient in the cured product 2. Due to the alicyclic structure having that three-dimensional structure, it also serves the function of suppressing a decrease in birefringence caused by component (A).

The resin composition of the present disclosure may also contain a polymerizable compound having a monofunctional (meth)acrylate polymerizable functional group, which is the monomer before polymerization of the above component (C), in order to serve the function of lowering the water absorption expansion coefficient. It may also further contain a polymerizable compound having a bifunctional (meth)acrylate polymerizable functional group and having an alicyclic skeleton represented by the above structural formulae (2) to (4) and general formula (5).

In the present disclosure, the composition of the above components (A) to (C) is such that component (A) is 3 parts by mass or more and 20 parts by mass or less, component (B) is 50 parts by mass or more and 80 parts by mass or less, and component (C) is 5 parts by mass or more and 30 parts by mass or less. Preferably, component (A) is 3 parts by mass or more and 10 parts by mass or less, component (B) is 60 parts by mass or more and 80 parts by mass or less, and component (C) is 5 parts by mass or more and 20 parts by mass or less. When containing the polymerizable compound having a monofunctional (meth)acrylate polymerizable functional group, which is the monomer before polymerization of the above-mentioned component (C), it is preferably added to the components (A) to (C) in a range of 5 parts by mass or more and 25 parts by mass or less, and the total with component (C) is preferably 10 parts by mass or more and 30 parts by mass or less.

Examples of component (A) include compounds represented by the following general formulae (7) and (8).

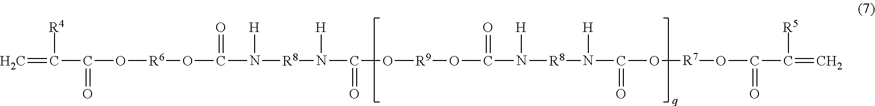

In the above general formula (7), R₄ and R₅ are each independently a hydrogen atom or a methyl group, R₆ and R₇ are each independently a hydrocarbon group having 1 to 10 carbon atoms, R₈ is an isocyanate residue, R₉ is a polyol residue or a polyester residue, and q is an integer of 0 to 10.

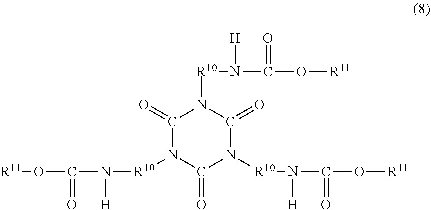

In the above general formula (8), R₁₀ is a hydrocarbon group having 1 to 10 carbon atoms, and R₁₁ is a substituent represented by the following general formula (9) or (10).

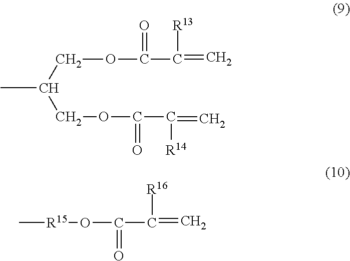

In the above general formulae (9) and (10), R₁₃, R₁₄, and R₁₆ are each independently a hydrogen atom or a methyl group, and R₁₅ is a hydrocarbon group having 1 to 10 carbon atoms.

The weight-average molecular weight (Mw) of component (C) is preferably in the range of 35,000 or more and 300,000 or less. If it is less than 35,000, the yield in the method for manufacturing the cured product 2 described later decreases. If it exceeds 300,000, there is a risk that compatibility with other components will become insufficient.

The polymerization initiator as component (D) may be either a photopolymerization initiator or a thermal polymerization initiator, and can be determined according to the manufacturing process to be selected. However, when performing replica molding to produce an aspherical shape, a photopolymerization initiator is preferable from the viewpoint of a fast curing speed. Commercially available photopolymerization initiators include, for example, 2-benzyl-2-dimethylamino-1-(4-morpholinophenyl)-1-butanone, 1-hydroxycyclohexyl phenyl ketone, bis(2,4,6-trimethylbenzoyl)-phenylphosphine oxide, 4-phenylbenzophenone, 4-phenoxybenzophenone, 4,4′-diphenylbenzophenone, and 4,4′-diphenoxybenzophenone. The content of the photopolymerization initiator in the resin composition is preferably 0.01 parts by mass or more and 10 parts by mass or less per 100 parts by mass of the total of the above-mentioned components (A) to (C) and the polymerizable compound added as necessary. If the content of the photopolymerization initiator is less than 0.01 parts by mass, sufficient reactivity cannot be obtained, and if it exceeds 10 parts by mass, there is a risk that the transmittance of the cured product 2 will decrease. Note that unreacted polymerization initiator remains in the cured product 2.

The resin composition may also have added thereto, as necessary, a polymerization inhibitor, an antioxidant, a light stabilizer (HALS), an ultraviolet absorber, a silane coupling agent, a mold release agent, a pigment, a dye, or the like.

The refractive index nd of the cured product 2 according to the present disclosure at the d-line (587.6 nm) is 1.54 or higher, and preferably 1.58 or lower. Increasing the refractive index can enhance the aspherical effect of the cured product 2, which is correlated with the product of the refractive index and the thickness. With the cured product disclosed in U.S. Pat. No. 7,070,862, when it was formed on a transparent substrate with a refractive index nd of 1.54 or higher, birefringence sometimes became large. However, according to the present disclosure, it is possible to provide the cured product 2, which has small birefringence and whose optical performance is less prone to change even in a high-humidity environment.

The glass transition point (Tg) of the cured product 2 is preferably 100° C. or higher and 180° C. or lower, and more preferably 105° C. or higher and 160° C. or lower. If the glass transition point is less than 100° C., distortion occurs in the image at high temperatures, and if it is greater than 180° C., the resin or glass may crack, or the resin may peel off from the glass in environmental tests.

In FIG. 1, the thickness of the cured product 2 is not uniform within the plane of the first surface 1A. That is, the shape of the surface of the cured product 2 that is not in contact with the transparent substrate 1 is aspherical. In the present embodiment, it has a thickness distribution that becomes a thin minimum thickness d1 near the center O of the optical element 10 and becomes a maximum thickness d2 at the peripheral part of the optical element 10, but it does not necessarily have to have this shape. For example, it may have a thickness distribution such that it has a maximum thickness d2 near the center O of the optical element 10 and a minimum thickness d1 at the peripheral part of the element. The ratio of the maximum thickness d2 to the minimum thickness d1 of the cured product 2 is preferably greater than 1 and in a range of 30 or less. If it becomes larger than 30, there is a risk that surface accuracy cannot be maintained with high precision during curing shrinkage because the difference in thickness of the cured product 2 is large. It is more preferably 8 or more. Note that the minimum thickness d1 is preferably 300 μm or less, and the maximum thickness d2 is preferably in a range of 10 μm or more and 1000 μm or less.

The water absorption expansion coefficient of the cured product 2 provided on the transparent substrate 1 is preferably less than 0.50%. This is because fluctuations in optical characteristics due to water absorption expansion can be reduced. If the water absorption expansion coefficient is 0.50% or more, the change in the surface shape of the cured product 2 before and after water absorption is large, which may cause fluctuations in image quality when used in an optical system. For this reason, it is preferably less than 0.30%. Note that the water absorption expansion coefficient used is one measured with a water absorption expansion coefficient meter as the percentage change in length from 0% humidity to 90% humidity at a temperature of 60° C.

Note that although the optical element 10 is in a mode having the transparent substrate 1 in this embodiment, the transparent substrate 1 may not be included depending on the optical characteristics of the optical element 10.

### [Method for Manufacturing Optical Element]

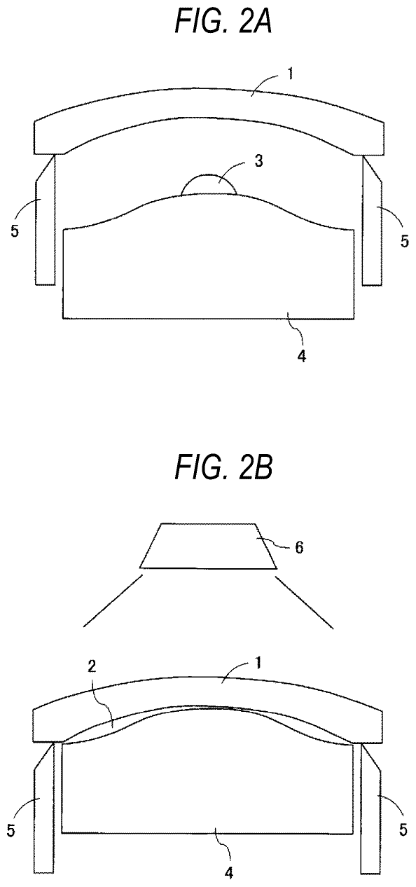

The method for manufacturing the optical element of the above-described embodiment is not particularly limited, but an example of a suitable manufacturing process will be described. FIGS. 2A and 2B are schematic diagrams illustrating a method for manufacturing the optical element according to the above-described embodiment.

First, a transparent substrate 1 and a resin composition 3 are prepared (preparation step). In order to improve the adhesion between the transparent substrate 1 and the cured product 2, it is preferable to perform a pretreatment on the first surface 1A of the transparent substrate. If the transparent substrate 1 is glass, for example, a silane coupling treatment, a corona discharge treatment, a UV ozone treatment, or a plasma treatment can be selected. From the viewpoint that adhesion can be further enhanced by directly chemically bonding the first surface 1A and the cured product 2, it is preferable to perform a coupling treatment using a silane coupling agent. Specific examples of the coupling agent include hexamethyldisilazane, methyltrimethoxysilane, trimethylchlorosilane, and triethylchlorosilane.

The method for obtaining the resin composition 3 is not particularly limited. The means and time for mixing are not particularly limited, and it is preferable to mix so as to become uniform.

Subsequently, as illustrated in FIG. 2A, the resin composition 3 is dropped onto the mold 4. In the present embodiment, the resin composition 3 is an ultraviolet-curable composition containing a photopolymerization initiator. The transparent substrate 1 is placed on the ejector 5 and arranged at a position facing the mold 4. The mold 4 is, for example, a metal mold that can be produced by cutting a NiP plating or an oxygen-free copper plating on a metal base material such as a stainless steel material or a steel material with a precision processing machine, having an inverted shape of a desired aspherical shape on its surface. A mold release agent may be applied to the surface of the mold 4 in order to control the mold release property of the resin. The type of mold release agent is not particularly limited, but examples include a fluorine coating agent.

Subsequently, as illustrated in FIG. 2B, by lowering the ejector 5 so that the mold 4 approaches the transparent substrate 1, the resin composition 3 is provided on the transparent substrate 1 (placement step). The ejector 5 is further lowered, the uncured resin composition 3 is filled between the mold 4 and the transparent substrate 1, and is molded into a desired shape (molding step).

Then, by irradiating the second surface 1B side of the transparent substrate 1 with ultraviolet light using an ultraviolet light source 6, a cured product 2, which is a polymerization product of the resin composition 3, is obtained (curing step, light irradiation step).

Thereafter, by releasing the cured product 2 from the mold 4, the optical element 10 having the aspherical-shaped cured product 2 on the transparent substrate 1 is obtained. Note that after forming the cured product 2, additional irradiation with ultraviolet light or heat treatment may be performed in the air or in an oxygen-free atmosphere.

The optical element of the present embodiment can be manufactured by the manufacturing method described above. Note that in the placement step, the resin composition 3 may be dropped on both the mold 4 and the transparent substrate 1, or may be dropped only on the transparent substrate 1. When the resin composition 3 contains a thermal polymerization initiator as a curing initiator, the light irradiation step may be changed to a heat treatment step. After the curing step, the transparent substrate 1 may be peeled off from the optical element 10, so that only the cured product 2 serves as the optical element 10.

### [Optical Instrument]

Specific application examples of the optical element of the above-described embodiment include a lens constituting an optical instrument (imaging optical system) for a camera or a video camera, a lens constituting an optical instrument (projection optical system) for a liquid crystal projector, and the like. It can also be used for a pickup lens of a DVD recorder or the like. These optical systems consist of at least one lens arranged in a housing, and the above-described optical element can be used for at least one of those lenses.

### [Imaging Apparatus]

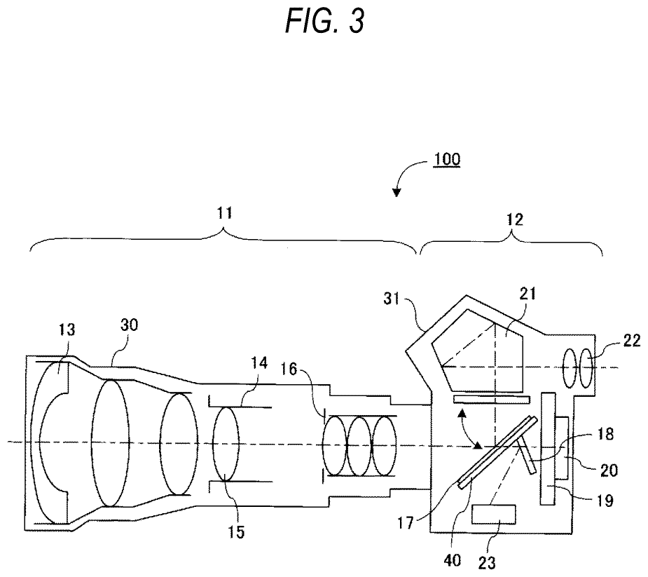

FIG. 3 is a schematic diagram illustrating a configuration of a single-lens reflex digital camera 100, which is an example of a preferred embodiment of an imaging apparatus using the optical element of the above-described embodiment. In FIG. 3, a camera body 12 and a lens barrel 11, which is an optical instrument, are coupled, but the lens barrel 11 is a so-called interchangeable lens that is detachable from the camera body 12.

Light from a subject is imaged via an optical system including a plurality of lenses 13, 15, etc. arranged on the optical axis of an imaging optical system inside a housing 30 of the lens barrel 11. The optical element of the present embodiment can be used for the lenses 13 and 15, for example. Here, the lens 15 is supported by an inner barrel 14 and is movably supported with respect to an outer barrel of the lens barrel 11 for focusing and zooming.

During an observation period before imaging, the light from the subject is reflected by a main mirror 17 inside a housing 31 of the camera body, passes through a prism 21, and then an imaged image is displayed to the imager through a finder lens 22. The main mirror 17 is, for example, a half-mirror, and the light that has passed through the main mirror is reflected by a sub-mirror 18 in the direction of an AF (autofocus) unit 23, and this reflected light is used, for example, for distance measurement. The main mirror 17 is mounted and supported on a main mirror holder 40 by adhesion or the like. At the time of imaging, the main mirror 17 and the sub-mirror 18 are moved out of the optical path via a drive mechanism (not illustrated), a shutter 19 is opened, and an imaging element 20 receives the light that has entered from the lens barrel 11 and passed through the imaging optical system to form an imaged optical image. An aperture stop 16 is configured to be able to change the brightness and depth of focus during imaging by changing the aperture area.

Note that although the imaging apparatus has been described here using a single-lens reflex digital camera, it can be similarly used for smartphones, compact digital cameras, drones, and the like.

### EXAMPLES

Hereinafter, description will be given with reference to Examples and Comparative Examples. First, methods for measuring and evaluating the physical properties of the Examples and Comparative Examples will be described.

### (Molecular Weight of Component (C))

The weight-average molecular weight (Mw) is a value in terms of polymethyl methacrylate, and can be measured, for example, by gel permeation chromatography (GPC). More specifically, first, a calibration curve is created from the elution time and weight-average molecular weight using a polymethyl methacrylate resin whose monodisperse weight-average molecular weight (Mw) is known and available as a reagent, and an analytical gel column that elutes high-molecular-weight components first. Then, based on the obtained calibration curve, the weight-average molecular weight (Mw) can be determined. Specifically, RID-20A (manufactured by Shimadzu Corporation) was used as a differential refractive index detector, LF-404 (manufactured by Resonac Corporation) was used as an analytical column, LF-G (manufactured by Resonac Corporation) was used as a guard column, and tetrahydrofuran was used as an eluent.

### (Glass Transition Point (Tg) of Cured Product)

A resin composition was filled between two 100 mm×100 mm×5 mm quartz substrates via a 0.2 mm spacer, and its entire surface was irradiated with ultraviolet light with an intensity of 10 mW/cm² at a wavelength of 405 nm for 200 seconds to obtain a cured product. The obtained cured product was cut into a strip shape of 5 mm in width×20 mm in length×0.2 mm in thickness, fixed at a length of 14.2 mm with a dynamic viscoelasticity measuring device (Rheogel-E4000, manufactured by UBM Co., Ltd.), and the elastic modulus behavior from 24° C. to 230° C. was measured to determine the glass transition point.

(Refractive Index Nd at d-Line)

The refractive index nd of the cured products of the optical elements of the Examples and Comparative Examples was evaluated by preparing a sample for optical characteristic evaluation. Note that it is also possible to peel the transparent substrate from the optical element, take out the cured product, and evaluate it, without using a sample for optical characteristic evaluation. First, a method for preparing a sample for optical characteristic evaluation will be described.

On a glass plate with a thickness of 1 mm (S-TIH, manufactured by OHARA INC.), a spacer with a thickness of 500 μm and an uncured resin composition, which is a precursor of the cured product to be measured, were placed. A quartz glass with a thickness of 1 mm was placed on top of it via the spacer, and the uncured resin composition was spread out. Next, the spacer was removed, the glass S-TIM8 used for the element was further placed on the quartz glass, and from above, light was directed for 2500 seconds (50 J/cm²) at 20 mW/cm² (=illuminance at a wavelength of 405 nm through the quartz glass and S-TIM8) using a high-pressure mercury lamp (UL750, manufactured by HOYA CANDEO OPTRONICS CORPORATION). The resin composition was cured, the quartz glass was peeled off, and the resulting product was annealed at 80° C. for 16 hours to be used as a sample for optical characteristic evaluation. The shape of the cured product cured by this method was 500 μm in thickness, and the size within the glass plane was 5 mm×20 mm.

For the obtained sample, the refractive index nd at the d-line (587.6 nm) of P-polarized light (thickness direction) and S-polarized light (in-plane direction of the incident surface) was measured from the glass side using a refractometer (KPR-30, manufactured by Shimadzu Corporation). The measurement was performed multiple times, and the average value was taken as the refractive index.

### (Water Absorption Expansion Coefficient)

For the water absorption expansion coefficient of the cured products of the optical elements of the Examples and Comparative Examples, a cured product of 5 mm×20 mm (measurement site is 15 mm)×0.2 mm was prepared, and the amount of expansion from 0% humidity to 90% humidity at a temperature of 60° C. was measured with a water absorption expansion coefficient meter (TMA8310/HUM: manufactured by Rigaku Corporation). From the length DO at 60° C. and 0% and the length D1 at 60° C. and 90%, the water absorption expansion coefficient [%] of the optical element was calculated using the following formula.

Water absorption expansion coefficient [%]=((D1−D0)/D0)×100

The evaluation was performed as follows.
A: Water absorption expansion coefficient is less than 0.30%
B: Water absorption expansion coefficient is 0.50% or less
C: Water absorption expansion coefficient exceeds 0.50%

### (Distortion Under High-Temperature Environment)

The optical elements of the Examples and Comparative Examples were compared by imaging under a room temperature environment (23° C.±2° C.) and imaging at a lens barrel temperature of 80° C. The evaluation criteria are as follows.
G (Good): Compared to room temperature imaging, no distortion was observed in the imaging at 80° C.
F (Fair): Compared to room temperature imaging, slight distortion was observed in the imaging at 80° C.
P (Poor): Compared to room temperature imaging, distortion was observed in the imaging at 80° C.

### (Temperature Cycle Test)

For the optical elements of the Examples and Comparative Examples, a temperature cycle test was performed, consisting of 3 cycles with one cycle being 5 hours in a 60° C. constant temperature bath and 5 hours in a −30° C. constant temperature bath, and the presence or absence of cracks or peeling was confirmed. Those with no cracks or peeling were rated “G,” and those with cracks or peeling were rated “P.” (Minimum Thickness d1, Maximum Thickness d2)

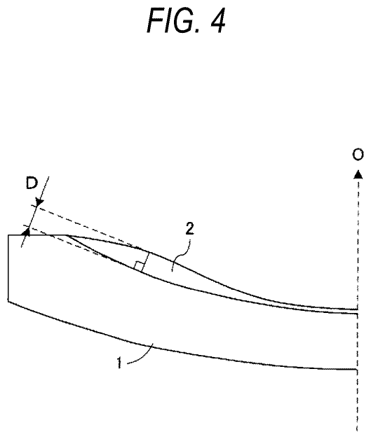

The minimum thickness d1 and maximum thickness d2 of the cured products of the optical elements of the Examples and Comparative Examples were evaluated using an optical element in which a cured product was provided on a transparent substrate. First, the produced optical element was placed in a 80° C. constant temperature bath for 16 hours. Subsequently, the optical element was taken out into a room temperature environment (23° C.±2° C.), and after 20 minutes, the surface shape of the cured product was evaluated using a shape measuring instrument (Form Talysurf LASER, manufactured by TAYLOR-HOBSON). The measurement was performed by light scanning in a straight line from the end of the optical element, through the center, to the opposite end, and the scanning speed was 0.5 mm/sec. The vertical distance from the interface between the transparent substrate and the cured product to the measured surface shape of the cured product was calculated to obtain the thickness D of the cured product. The thickness D is shown in FIG. 4. Furthermore, the average value of the obtained thickness in the radial direction was taken as DO, the minimum thickness was taken as d1, and the maximum thickness was taken as d2.

### [Production of Optical Element]

The components used in the Examples and Comparative Examples are as follows.

### <Component (A)>

A-1: Polyfunctional urethane-modified (meth)acrylate (in general formula (8), R₁₀ is a hydrocarbon group having 2 carbon atoms, R₁₁ is represented by general formula (10), R₁₅ is a hydrocarbon group having 2 carbon atoms (—(CH₂)₂—), and R₁₆ is hydrogen)
A-2: Polyfunctional urethane-modified (meth)acrylate (in general formula (7), R₄ and R₅ are each hydrogen, R₆ to R₈ are each a hydrocarbon group having 4 carbon atoms (—(CH₂)₄—), and q is 6 on average)

### <Component (B)>

B-1: EO adduct diacrylate of bisphenol A (following structural formula (11), m+n=3.0)

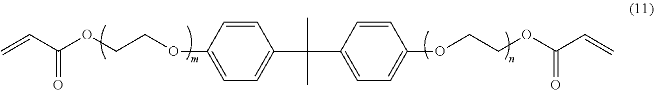

B-2: EO adduct dimethacrylate of bisphenol A (following structural formula (12), m+n=2.3, note that the reason why the sum of m+n is a decimal is that it is an average of a mixture of multiple substances where m+n is 2, 3, 4, etc.)

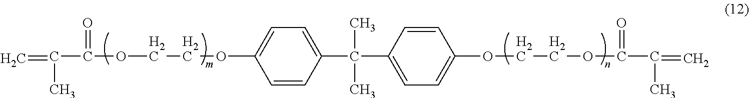

### <Component (C)>

C-1: Dicyclopentanyl methacrylate polymer (in general formula (6), X is structural formula (2), n=0)
C-2: Dicyclopentenyloxyethyl methacrylate polymer (in general formula (6), X is structural formula (3), n=1)
C-3: Isobornyl methacrylate polymer (in general formula (6), X is structural formula (4), n=0) C-4:2-Ethyl-2-methacryloyloxyadamantane polymer (in general formula (6), X is general formula (5), R is an ethyl group, n=0)

### <Component (D) (Photopolymerization Initiator)>

D-1: Diphenyl(2,4,6-trimethylbenzoyl) phosphine oxide (following structural formula (13))

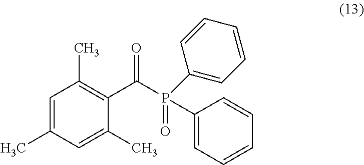 [SMILES: Cc1cc(C)c(C(=O)P(=O)(c2ccccc2)c2ccccc2)c(C)c1]

### <Component (E) (Other Components)>

E-1: Dicyclopentanyl methacrylate (following structural formula (14))

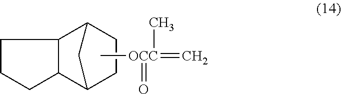

E-2: Dicyclopentenyloxyethyl methacrylate (following structural formula (15))

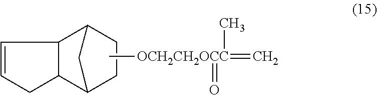

E-3: Isobornyl methacrylate (following structural formula (16))

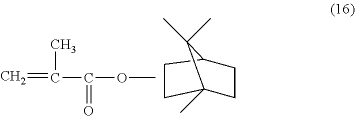

E-4:2-Ethyl-2-methacryloyloxyadamantane (following structural formula (17))

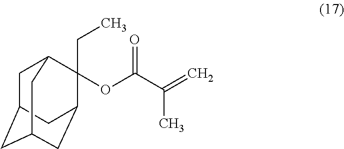 [SMILES: C=C(C)C(=O)OC1(CC)C2CC3CC(C2)CC1C3]

### Example 1

Each component (A) to (E) described in Tables 1-1 and 1-2 was placed in a bottle in the parts by mass described in Tables 1-1 and 1-2, mixed so as to become uniform, and a resin composition was obtained.

Next, using the manufacturing method illustrated in FIGS. 2A and 2B, the optical element illustrated in FIG. 1 was manufactured. As the transparent substrate 1, an optical glass with a diameter of 32 mm (S-TIM8, manufactured by OHARA INC.) was prepared. The shape was a concave spherical shape with a radius of curvature of 40 mm on one surface (first surface 1A) and a convex spherical shape with a radius of curvature of 75 mm on the other surface (second surface 1B). As the mold 4, one was used in which a NiP layer plated on a metal base material was cut with a precision processing machine to form a shape that was an inversion of the aspherical shape of the cured product 2 to be molded.

Subsequently, the above resin composition was filled between the transparent substrate 1 and the mold 4. Thereafter, the entire surface was irradiated with ultraviolet light with an intensity of 10 mW/cm² at a wavelength of 405 nm for 200 seconds. After releasing the mold 4, by heating at 80° C. for 24 hours, the cured product 2 was formed on the first surface 1A of the transparent substrate 1, and the optical element 10 of Example 1 was obtained. For the obtained optical element, each of the above evaluations was performed. The evaluation results are shown in Tables 1-1 and 1-2.

### Examples 2 to 5, Comparative Examples 1 and 2

An optical element was produced and evaluated in the same manner as in Example 1, except that the composition of the resin composition was changed to the composition shown in Tables 1-1 and 1-2. The evaluation results are shown in Tables 1-1 and 1-2.

TABLE 1-1

| | | Example 1 | | Example 2 | | Example 3 | | Example 4 | | Example 5 | |
|---|---|---|---|---|---|---|---|---|---|---|---|
| Composition | Component | A-1 | 5 | A-1 | 5 | A-2 | 5 | A-1 | 5 | A-1 | 5 |
| | (A) [parts by | | | | | | | | | | |
| | mass] | | | | | | | | | | |
| | Component | B-1 | 75 | B-2 | 75 | B-2 | 75 | B-1 | 75 | B-1 | 75 |
| | (B) [parts by | | | | | | | | | | |
| | mass] | | | | | | | | | | |
| | Component | C-1 | 10 | C-2 | 10 | C-2 | 10 | C-3 | 10 | C-4 | 10 |
| | (C) [parts by | | | | | | | | | | |
| | mass] | | | | | | | | | | |
| | Component | D-1 | 0.5 | D-1 | 0.5 | D-1 | 0.5 | D-1 | 0.5 | D-1 | 0.5 |
| | (D) [parts by | | | | | | | | | | |
| | mass] | | | | | | | | | | |
| | Component | E-1 | 10 | E-2 | 10 | E-2 | 10 | E-3 | 10 | E-4 | 10 |
| | (E) [parts by | | | | | | | | | | |
| | mass] | | | | | | | | | | |
| Molecular Weight of | | 180000 | | 90000 | | 90000 | | 200000 | | 160000 | |
| Component (C) | | | | | | | | | | | |
| Tg (° C.) | | 113 | | 149 | | 146 | | 117 | | 120 | |
| Evaluation | Refractive | 1.551 | | 1.550 | | 1.549 | | 1.551 | | 1.551 | |
| | Index | | | | | | | | | | |
| | Water | 0.41% | | 0.29% | | 0.30% | | 0.41% | | 0.41% | |
| | Absorption | | | | | | | | | | |
| | Expansion | | | | | | | | | | |
| | Coefficient | | | | | | | | | | |
| | Water | B | | A | | A | | B | | B | |
| | Absorption | | | | | | | | | | |
| | Expansion | | | | | | | | | | |
| | Coefficient | | | | | | | | | | |
| | Evaluation | | | | | | | | | | |
| | Image | G | | G | | G | | G | | G | |
| | Distortion | | | | | | | | | | |
| | under High- | | | | | | | | | | |
| | Temp. | | | | | | | | | | |
| | Environment | | | | | | | | | | |
| | Temperature | G | | G | | G | | G | | G | |
| | Cycle Test | | | | | | | | | | |
| | Minimum | 50 μm | | 50 μm | | 50 μm | | 50 μm | | 50 μm | |
| | Thickness d1 | | | | | | | | | | |
| | Maximum | 400 μm | | 400 μm | | 400 μm | | 400 μm | | 400 μm | |
| | Thickness d2 | | | | | | | | | | |

| | | | | | |
|---|---|---|---|---|---|
| d2/d1 | 8.0 | 8.0 | 8.0 | 8.0 | 8.0 |

TABLE 1-2

| | |
|---|---|
| Comparative | Comparative |
| Example 1 | Example 2 |

| | | | | | |
|---|---|---|---|---|---|
| Composition | Component | A-2 | 19.5 | A-1 | 19.5 |
| | (A) [parts by | | | | |
| | mass] | | | | |
| | Component | B-1 | 80 | B-1 | 80 |
| | (B) [parts by | | | | |
| | mass] | | | | |
| | Component | — | — | — | — |
| | (C) [parts by | | | | |
| | mass] | | | | |
| | Component | D-1 | 0.5 | D-1 | 0.5 |
| | (D) [parts by | | | | |
| | mass] | | | | |
| | Component | — | — | — | — |
| | (E) [parts by | | | | |
| | mass] | | | | |

| | | |
|---|---|---|
| Molecular Weight of | — | — |

Component (C)

| Tg (° C.) | | 97 | 101 |
|---|---|---|---|
| Evaluation | Refractive | 1.547 | 1.552 |

Index

| | | |
|---|---|---|
| Water | 0.63% | 0.54% |

Absorption
Expansion
Coefficient

| | | |
|---|---|---|
| Water | C | C |

Absorption
Expansion
Coefficient
Evaluation

| | | |
|---|---|---|
| Image | P | F |

Distortion
under High-
Temp.
Environment

| | | |
|---|---|---|
| Temperature | G | G |

Cycle Test

| | | |
|---|---|---|
| Minimum | 50 μm | 50 μm |

Thickness d1

| | | |
|---|---|---|
| Maximum | 400 μm | 400 μm |

Thickness d2

| | | |
|---|---|---|
| d2/d1 | 8.0 | 8.0 |

According to the present disclosure, it is possible to provide an optical element that has a low water absorption expansion coefficient, whose optical performance is less prone to fluctuate even under a high-temperature environment, and that has excellent durability. It is also possible to provide a resin composition used for the optical element, and an optical instrument and an imaging apparatus using the optical element.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-177199, filed Oct. 9, 2024, which is hereby incorporated by reference herein in its entirety.

What is claimed is:

1. A resin composition, comprising at least the following components (A) to (C):
(A) a polyfunctional urethane-modified (meth)acrylate compound;
(B) a bifunctional (meth)acrylate compound having a bisphenol skeleton represented by the following general formula (1); and
(C) a polymer represented by the following general formula (6) having at least one alicyclic skeleton represented by the following structural formulae (2) to (4) and general formula (5) 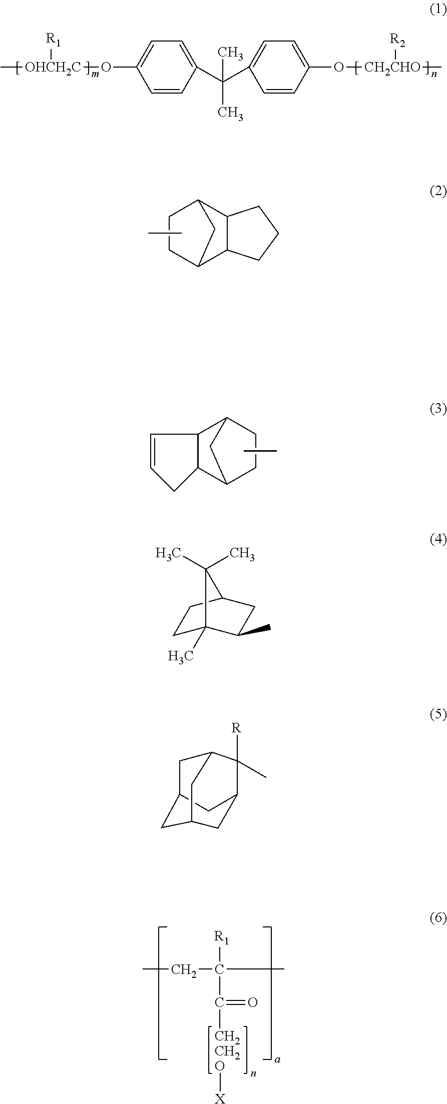
wherein in the above general formula (1), R₁ and R₂ each independently represent a hydrogen atom or a methyl group, and m and n represent numerical values;
in the above general formula (5), R is a hydrogen atom, an alkyl group, or a substituted or unsubstituted alkylene group; and
in the above general formula (6), R₁ represents a hydrogen atom or a methyl group, n is 0 or 1, a represents a numerical value, and X represents an alicyclic skeleton represented by any of the above structural formulae (2) to (4) and general formula (5).

2. The resin composition according to claim 1, wherein the component (A) is contained at 3 parts by mass or more and 20 parts by mass or less, the component (B) is contained at 50 parts by mass or more and 80 parts by mass or less, and the component (C) is contained at 5 parts by mass or more and 30 parts by mass or less.

3. The resin composition according to claim 1, wherein the component (A) is a compound represented by the following general formula (7): 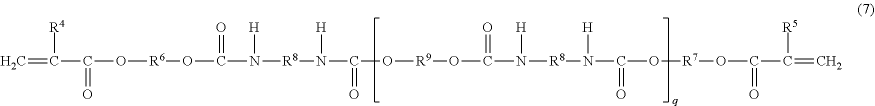
wherein in the above general formula (7), R₄ and R₅ are each independently a hydrogen atom or a methyl group, R₆ and R₇ are each independently a hydrocarbon group having 1 to 10 carbon atoms, R₈ is an isocyanate residue, R₉ is a polyol residue or a polyester residue, and q is an integer of 0 to 10.

4. The resin composition according to claim 1, wherein the component (A) is a compound represented by the following general formula (8): 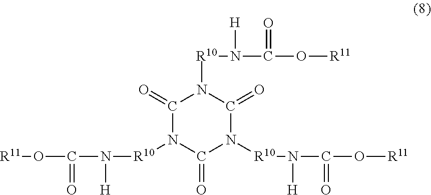
wherein in the above general formula (8), R₁₀ is a hydrocarbon group having 1 to 10 carbon atoms, and R₁₁ is a substituent represented by the following general formula (9) or (10): 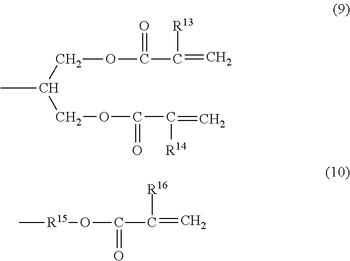
wherein in the above general formulae (9) and (10), R₁₃, R₁₄, and R₁₆ are each independently a hydrogen atom or a methyl group, and R₁₅ is a hydrocarbon group having 1 to 10 carbon atoms.

5. The resin composition according to claim 1, further comprising a polymerizable compound having a monofunctional (meth)acrylate polymerizable functional group and having at least one alicyclic skeleton represented by the above structural formulae (2) to (4) and general formula (5).

6. The resin composition according to claim 1, further comprising a polymerization initiator.

7. An optical element including a cured product of the resin composition according to claim 1,
wherein the cured product has a glass transition point of 105° C. or higher and 160° C. or lower, and
the cured product has a refractive index at a d-line of 1.54 or higher.

8. The optical element according to claim 7, further comprising a transparent substrate, wherein the cured product is provided on the transparent substrate.

9. The optical element according to claim 8, wherein the transparent substrate has a first surface with a concave spherical shape, and
the cured product is provided on the first surface.

10. The optical element according to claim 7, wherein the cured product has a water absorption expansion coefficient from 0% humidity to 90% humidity at 60° C. of 0.50% or less.

11. The optical element according to claim 7, wherein the cured product has a refractive index at a d-line of 1.58 or lower.

12. The optical element according to claim 7, wherein a ratio of a maximum thickness d2 to a minimum thickness d1 of the cured product is greater than 1 and 30 or less.

13. The optical element according to claim 12, wherein the minimum thickness d1 is 300 μm or less, and
the maximum thickness d2 is in a range of 10 μm or more and 1000 μm or less.

14. An optical instrument comprising a housing and an optical system having at least one lens disposed within the housing,
wherein at least one of the lenses is the optical element according to claim 7.

15. An imaging apparatus comprising a housing, an optical system having at least one lens disposed within the housing, and an imaging element that receives light that has passed through the optical system,
wherein at least one of the lenses is the optical element according to claim 7.
